(19) United States
(12) Patent Application Publication
(10) Pub. No.: US 2012/0175871 A1
(43) Pub. Date: Jul. 12, 2012

(54) PIPE CONNECTOR AND PIPE ASSEMBLY USING SAME

(76) Inventor: Wen-Ying WANG, Shenzhen (CN)

(21) Appl. No.: 12/985,974

(22) Filed: Jan. 6, 2011

(51) Int. Cl. F16L 55/00; F16L 23/00

(52) U.S. Cl. 285/148.19; 285/405

(57) ABSTRACT

A pipe connector includes a first connection unit having a first tube for the connection of an external water pipe, a first hole extending through two distal ends of the first tube, a plurality of annular flanges extending around the periphery of the first tube and a rotation prevention portion for preventing rotation of the connected external water pipe relative to the first tube; and a second connection unit defining therein a second hole in communication with the first hole of the first connection unit. The invention also provides a pipe assembly using the pipe connector.

### BACKGROUND OF THE INVENTION

1. Field of the Invention

The present invention relates to pipe connectors and more particularly, to a pipe connector, which prevents rotation of the connected pipe relative to the pipe connector. The invention relates also to a pipe assembly using the pipe connector.

2. Description of the Related Art

A conventional pipe connector generally has a plurality of barbed flanges spaced along the length for preventing separation of the connected water pipe.

However, because the barbed flanges are annular flanges extending around the periphery of the pipe connector, the connected water pipe may be rotated relative to the pipe connector when receiving an external biasing force. Frequent rotation of the connected water pipe relative to the pipe connector may cause wearing damage and tangling of the water pipe. When this situation occurs, the pipe hole of the water pipe will be deformed, reducing the flow rate or stopping the delivery of water. Further, frequent rotation of the connected water pipe relative to the pipe connector will also affect the sealing condition and connection tightness. Therefore, an improvement in this regard is necessary.

### SUMMARY OF THE INVENTION

The present invention has been accomplished under the circumstances in view. It is the main object of the present invention to provide a pipe connector and a pipe assembly using the pipe connector, which prevents rotation of the connected water pipe relative to the pipe connector without affecting the sealing effect.

To achieve this and other objects of the present invention, a pipe connector includes a first connection unit, which comprises a first tube for the connection of an external water pipe, a first hole extending through two distal ends of the first tube, a plurality of annular flanges extending around the periphery of the first tube and spaced along the length of the first tube and at least one rotation prevention portion for preventing rotation of the connected external water pipe relative to the first tube, and at least one second connection unit each defining therein a second hole in communication with the first hole of the first connection unit.

To achieve this and other objects of the present invention, a pipe assembly includes the aforesaid pipe connector, and a water pipe comprising a pipe hole and a pipe wall surrounding the pipe hole for attaching to the first tube, annular flanges and rotation prevention portion of the pipe connector.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic elevational assembly view of a pipe assembly in accordance with a first embodiment of the present invention.

FIG. 2 is an exploded view of the pipe assembly in accordance with the first embodiment of the present invention.

FIG. 3 is a sectional view of the pipe assembly in accordance with the first embodiment of the present invention.

FIG. 4 is an exploded view in section of the pipe assembly in accordance with the first embodiment of the present invention.

FIG. 5 is an elevational view of a pipe connector in accordance with a second embodiment of the present invention.

FIG. 6 is an elevational view of a pipe connector in accordance with a third embodiment of the present invention.

### DETAILED DESCRIPTION OF THE INVENTION

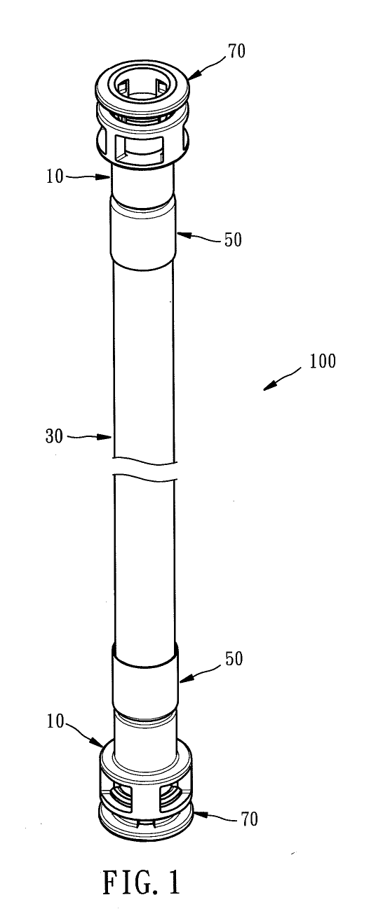

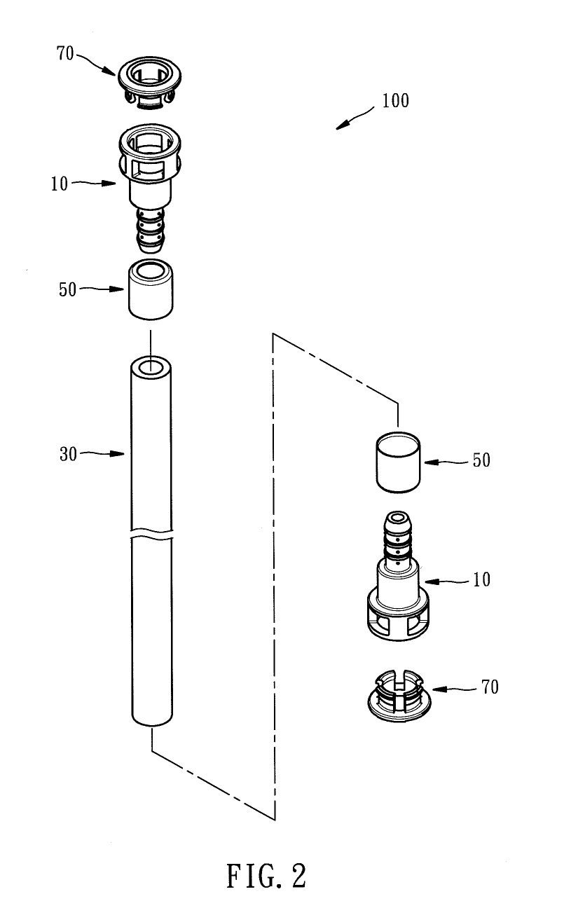

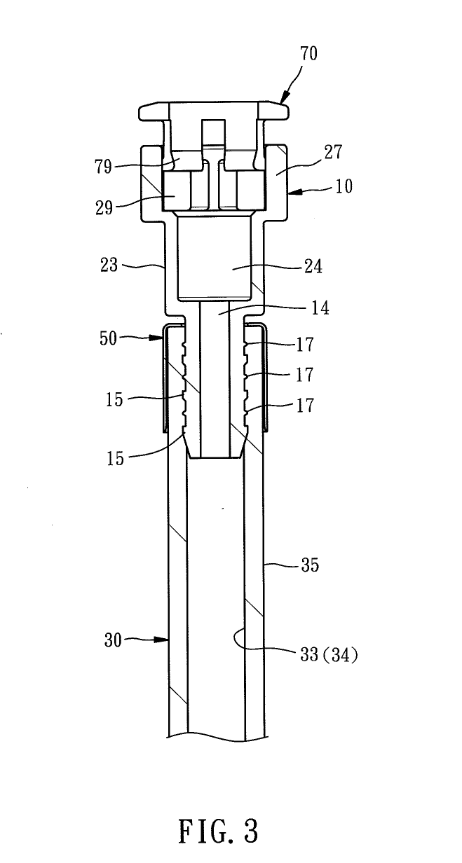

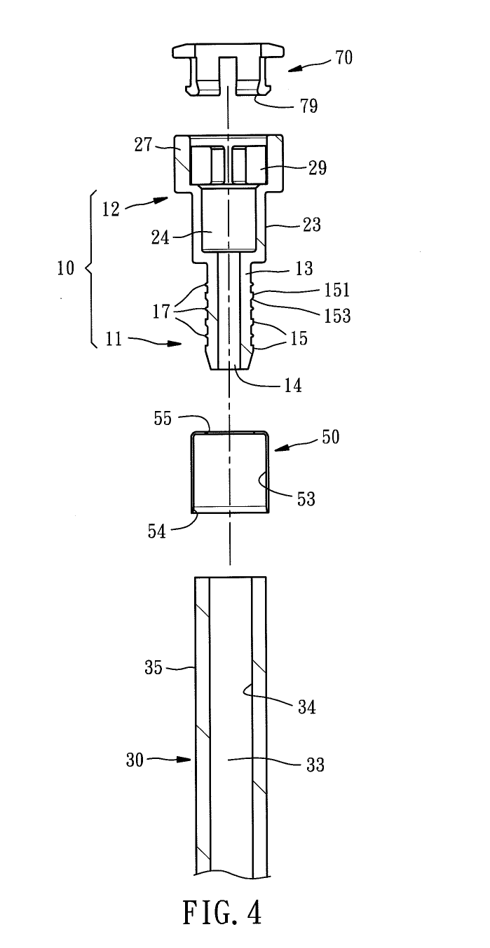

Referring to FIGS. 1˜4, the invention provides a pipe connector 10 and a pipe assembly 100 using the pipe connector 10.

A pipe connector 10 in accordance with a first embodiment of the present invention includes a first connection unit 11 and a second connection unit 12. The first connection unit 11 comprises a first tube 13, a first hole 14 extending through two distal ends of the first tube 13, a plurality of, for example, three annular flanges 15 extending around the periphery of the first tube 13 and spaced along the length of the first tube 13, and a plurality of beads 17 protruded from the periphery of the first tube 13. The annular flanges 15 are shaped like an inverted gutter, each having an enclosed portion 151 and a conical portion 153. The beads 17 are respectively arranged around the periphery of the first tube 13 between each two adjacent annular flanges 15 and between one end of the second connection unit 12 and one adjacent annular flange 15. The beads 17 can be made in a conical or semispherical shape. However, the beads 17 can also be made in any of a variety of other shapes. Further, the beads 17 that are disposed in one same radial direction are spaced from one another at 90-degrees. Further, the height of the beads 17 is less than or equal to the height of the annular flange 15.

The second connection unit 12 comprises a second tube 23 connected to the first tube 13 of the first connection unit 11, a second hole 24 defined in the second tube 23 in communication with the first hole 14 of the first connection unit 11, a hollow adapter connection port 27 disposed in communication with one end of the second hole 24 opposite to the first connection unit 11, and a plurality of escape holes 29 formed in the hollow adapter connection port 27.

The pipe connector 10 is adapted for the connection of a water pipe 30. The water pipe 30 is attached the first tube 13 and secured in place by the annular flanges 15 and the beads 17.

A pipe assembly 100 using the pipe connector 10 in accordance with the present invention comprises a water pipe 30, a pipe binder 50 and a quick release adapter 70.

The water pipe 30 comprises a pipe wall 34 and a pipe hole 33 surrounded by the pipe wall 34 and adapted for receiving the first tube 13, annular flanges 15 and beads 17 of the aforesaid pipe connector 10.

The pipe binder 50 has a tubular inside wall 53 attached to the periphery 35 of the water pipe 30 over the annular flanges 15 and beads 17 of the pipe connector 10, a tapered orifice 54 located on one end of the inside wall 53 and gradually increasing toward the outside to facilitate insertion of one end of the water pipe 30 into the tubular inside wall 53 and a neck portion 55 located on the other end of the inside wall 53 and disposed adjacent to the second connection unit 12 of the pipe connector 10. The pipe binder 50 can be made of elastic plastics and directly press-fitted onto the water pipe 30. Alternatively, the pipe binder 50 can be made of metal and capped on one end of the pipe tube 30, and then crimped and firmly secured to the periphery of the water pipe 30.

The quick release adapter 70 is detachably fastened to the hollow adapter connection port 27 of the pipe connector 10, having a plurality of spring hooks 79 for hooking in the escape holes 29 of the hollow adapter connection port 27 of the pipe connector 10.

In a test made on a sample of the pipe connector 10 in the form of a two-way pipe, the pipe connector 10 exhibits a bending strength not less than 8.0 N.m, better than the convention designs without beads.

Further, because the height of the beads 17 is less than or equal to the height of the annular flange 15, connection tightness and sealing effect between the pipe connector 10 and the water pipe 30 is assured.

Further, the aforesaid beads 17 constitute a rotation prevention portion. However, the rotation prevention portion is not limited to the design of the aforesaid beads 17. Any of a variety of other structures, shapes and sizes and arrangements can be selectively used to achieve the same function.

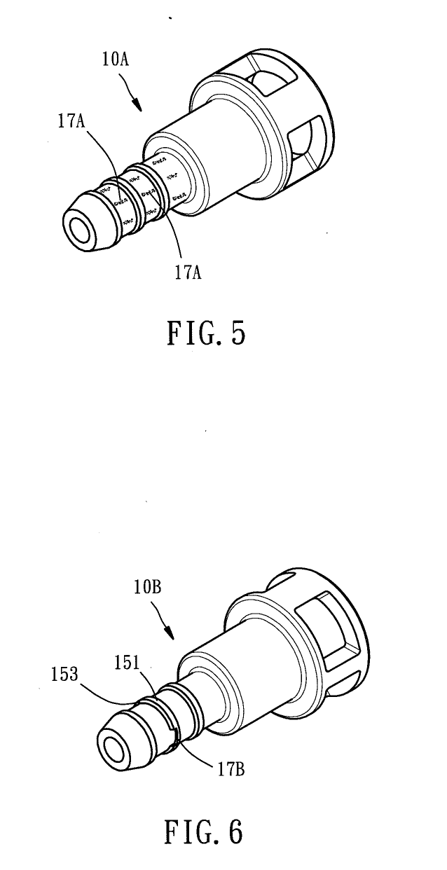

FIG. 5 illustrates a pipe connector 10A in accordance with a second embodiment of the present invention. This second embodiment is substantially similar to the aforesaid first embodiment with the exception of the rotation prevention portion. According to this second embodiment, the rotation prevention portion of the pipe connector 10A comprises a plurality of coarsened friction portions 17A raised from the periphery of the first tube 13.

FIG. 6 illustrates a pipe connector 10B in accordance with a third embodiment of the present invention. This third embodiment is substantially similar to the aforesaid first embodiment with the exception of the rotation prevention portion. According to this third embodiment, the rotation prevention portion of the pipe connector 10B is a notch 17B located on the enclosed portion 151 and conical portion 153 of one annular flanges 15. Alternatively, the notch 17B can be simply located on the enclosed portion 151 or conical portion 153 of one annular flange 15, achieving the same effect. Further, the rotation prevention portion formed in the annular flange 15 can be comprised of at least one raised means and/or at least one recessed means.

Further, the pipe connector and the pipe assembly using the pipe connector can be made in other alternate forms without departing from the spirit and scope of the invention.

For example, the number of the annular flange 15 can be more than or below three to fit different requirements.

Further, the pipe connector can be made in the form of a three-way or multi-way pipe, comprising one first connection unit 11 and multiple second connection units 12. In a test made on a sample of the pipe connector in the form of a three-way pipe exhibits a bending strength not less than 10.0 N.m.

Further, the pipe binder 50 can be eliminated from the pipe assembly 100, enabling the water pipe 30 to be directly attached to the pipe connector and secured thereto by means of the deformative force of the material property.

Further, quick release adapter 70 can be eliminated from the pipe assembly 100, enabling the pipe connector to be connected with an external pipe fitting (not shown) or connector (not shown) by any of a variety of other measures.

Further, the rotation prevention portion can be formed on a part or a set of parts which detachably assembled on the first connection unit of the pipe connector.

In conclusion, the invention provides a pipe connector and a pipe assembly using the pipe connector, which prevents rotation of the pipe relative to the pipe connector without affecting the sealing effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pipe connector, comprising:
a first connection unit, said first connection unit comprising a first tube for the connection of an external water pipe, a first hole extending through two distal ends of said first tube, a plurality of annular flanges extending around the periphery of said first tube and spaced along the length of said first tube, and at least one rotation prevention portion for preventing rotation of the connected external water pipe relative to said first tube; and
at least one second connection unit, each said second connection unit defining therein a second hole in communication with said first hole of said first connection unit.

2. The pipe connector as claimed in claim 1, wherein each said rotation prevention portion comprises a plurality of beads.

3. The pipe connector as claimed in claim 1, wherein each said rotation prevention portion comprises a plurality of friction portions.

4. The pipe connector as claimed in claim 1, wherein each said rotation prevention portion is located on said first tube.

5. The pipe connector as claimed in claim 1, wherein each said rotation prevention portion is located on said first tube between two adjacent annular flanges of said first connection unit.

6. The pipe connector as claimed in claim 1, wherein each said rotation prevention portion is located on at least one of said annular flanges of said first connection unit.

7. The pipe connector as claimed in claim 6, wherein each said rotation prevention portion comprises a notch located on one said annular flange of said first connection unit.

8. The pipe connector as claimed in claim 6, wherein each said rotation prevention portion comprises a raised portion protruded from one said annular flange of said first connection unit.

9. The pipe connector as claimed in claim 6, wherein each said rotation prevention portion comprises a recessed portion located on one said annular flange of said first connection unit.

10. The pipe connector as claimed in claim 6, wherein each said annular flange comprises an enclosed portion; said rotation prevention portion is located on the enclosed portion of one said annular flange.

11. The pipe connector as claimed in claim 6, wherein each said annular flange comprises a conical portion; said rotation prevention portion is located on the conical portion of one said annular flange.

12. The pipe connector as claimed in claim 1, wherein each said has a height smaller or equal to the height of said annular flanges.

13. The pipe connector as claimed in claim 1, wherein the number of said at least one second connection unit is at least two so that the pipe connector has the shape of a multi-way pipe.

14. The pipe connector as claimed in claim 1, wherein each said second connection unit comprises a second tube connected to said first connection unit.

15. A pipe assembly, comprising:
a pipe connector as claimed in claim 1; and
a water pipe, said water pipe comprising a pipe hole and a pipe wall surrounding said pipe hole for attaching to the first tube, annular flanges and rotation prevention portion of said pipe connector.

16. The pipe assembly as claimed in claim 15, further comprising a pipe binder sleeved onto the periphery of said water pipe over said annular flanges and said rotation prevention portion of said pipe connector.

17. The pipe assembly as claimed in claim 16, wherein said pipe binder comprises a neck portion disposed adjacent to the second connection unit of said pipe connector.

18. The pipe assembly as claimed in claim 16, wherein said pipe binder comprises a tapered orifice located on one end thereof and gradually increasing toward the outside.

19. The pipe assembly as claimed in claim 15, wherein said second connection unit of said pipe connector further comprises a hollow adapter connection port; the pipe assembly further comprises a quick release adapter detachably fastened to a hollow adapter connection port of said pipe connector for the connection of an external pipe.

20. The pipe assembly as claimed in claim 19, wherein said second connection unit of said pipe connector further comprises a plurality of escape holes located on the periphery of said hollow adapter connection port; said quick release adapter comprises a plurality of spring hooks for hooking in the escape holes of said pipe connector.
